(19) United States
(12) Patent Application Publication
(10) Pub. No.: US 2025/0046132 A1
(43) Pub. Date: Feb. 6, 2025

(54) METHOD AND DEVICE FOR PROVIDING AT LEAST ONE EMISSION VALUE FOR A MEANS OF TRANSPORT

(71) Applicant: JENOPTIK Robot GmbH, Monheim am Rhein (DE)

(72) Inventors: Stefan KIENITZ, Monheim am Rhein (DE); Andreas BEYER, HAMBURG (DE); Torben POTTHOFF, Monheim am Rhein (DE); Oliver BLANKE, Monheim am Rhein (DE)

(73) Assignee: JENOPTIK Robot GmbH, Monheim am Rhein (DE)

(21) Appl. No.: 18/720,322

(22) PCT Filed: Dec. 20, 2022
(86) PCT No.: PCT/EP2022/086948

§ 371 Date: Jun. 14, 2024

(30) Foreign Application Priority Data
Dec. 21, 2021 (DE) 10 2021 134 170.1

(51) Int. Cl. G07C 5/08; G07C 5/00; G08G 1/015; G08G 1/017; G08G 1/042

(52) U.S. Cl. CPC G07C 5/0825; G07C 5/008; G07C 5/085; G08G 1/015; G08G 1/017; G08G 1/042

(57) ABSTRACT

The approach proposed here relates to a method for providing at least one emission value for a means of transport. The method comprises a step of reading in an identification parameter that represents at least one type of the means of transport present in an observation area. The method furthermore comprises a step of ascertaining the at least one emission value for the means of transport from a memory that stores an assignment of the at least one type of the means of transport to the emission value, wherein the emission value represents a parameter of an emission coming from the means of transport into an environment of the means of transport. The method lastly comprises a step of outputting the ascertained emission value to an output interface in order to provide the emission value.

The invention is based on a device or a method according to the type of the independent claims. The subject matter of the present invention is also a computer program.

For regulating the emissions in road traffic, the type and quantity of emissions, for example, should be monitored for legal reasons. This is mainly done by means of chemical measurement methods at the edge of the roadway. The problem of such an approach is the complexity of the measurements and the overlapping of emissions from traffic and industry. This means that such measurements have to be carried out at a large number of locations. Furthermore, the chemical measurements are distorted by turbulence and winds. Measuring only one roadway, or one direction per roadway, is therefore very imprecise. The measuring probes must be serviced and replaced after a few measuring cycles. The installed chemical measuring stations can only measure emissions; further key parameters or indicators cannot be detected. A separate measuring station is therefore installed for each task. Although a combination of all measurement types can be achieved using IoT (Internet of Things), this is done using a large number of cost-intensive individual sensors on separate masts and housings.

The need for a solution to this problem exists in particular for the period of transition from combustion engines to pure electric mobility (if this happens). During this time, traffic continues to emit climate-damaging CO₂, which is to be quantified by law. Further emissions such as noise and particulate matter caused by abrasion will also be important for future vehicles.

### DISCLOSURE OF THE INVENTION

Against this background, the approach presented here introduces a method, and also a device using this method, and lastly a corresponding computer program according to the main claims. Advantageous developments and improvements of the device specified in the independent claim are possible via the measures set out in the dependent claims.

Presented here is a method for providing at least one emission value for a means of transport, wherein the method comprises the following steps:
reading in an identification parameter that represents at least one type of the means of transport present in an observation area;
ascertaining the at least one emission value for the means of transport from a memory that stores an assignment of the at least one type of the means of transport to the emission value, in particular wherein the emission value represents a parameter of an emission coming from the means of transport into an environment of the means of transport; and
outputting the ascertained emission value to an interface in order to provide the emission value.

For example, an emission value can be understood as a value or parameter that represents a quantity of a pollutant or, in general, an emission into the environment of the means of transport. For example, such an emission value can represent a type and/or quantity of a combustion product produced by an internal combustion engine during its operation, such as a gas (here in particular carbon dioxide and/or a nitrogen oxide) or a solid (here in particular particulate matter). For example, a means of transport can be a land-bound, water-bound and/or air-bound means of transport, such as a motor vehicle, ship or aircraft (including, in particular, drones (UAVs)). For the overall balance, the term “means of transport” is to be understood more abstractly and includes any kind of locomotion of road users; in particular, pedestrians (means of transport: feet, shoes), wheelchair users, skaters, cyclists, and moped riders are also included. An identification parameter can be understood as a feature or information that identifies a specific type of means of transport, for example a specific vehicle model of a vehicle manufacturer or else a particular, individual vehicle as such. The observation area can be a spatial region through which the means of transport moves or is present and in which the identification parameter of means of transport currently moving or present through this region is recorded and forwarded to an input interface. A memory can, for example, be understood as a unit with an assignment table stored therein, in which specific emission values are stored for individual types of means of transport or particular, individual vehicles and/or models. This makes it possible to ascertain a quantity and/or type of emission from the means of transport that is currently moving or present in the observation area.

The approach presented here is based on the knowledge that for almost all types and models of means of transport, the types and/or quantities of emissions emitted or produced during the operation of these means of transport have already been detected, measured or ascertained in advance. If a specific environmental impact caused by the movement of the means of transport in a particular area is to be ascertained, this knowledge can be used by detecting and/or reading in which means of transport and/or which type of means of transport is currently passing through the observation area, and determining the quantity and/or type of emission from the memory.

The approach presented here offers the advantage that the type and quantity of produced and/or emitted emissions caused by the operation of the means of transport can be ascertained very precisely. In this way, emissions that have already occurred or are expected to occur in the future can be ascertained and/or made available without the need for complex measurement infrastructure, and emissions from sources other than the means of transport considered here can be eliminated. For example, errors can be avoided if measuring stations on main roads in congested areas detect greatly increased values of particulate matter and/or nitrogen oxide, but these main roads are located in the vicinity of railroads or canals and the measurements from these measuring stations therefore provide measured values that may be falsified by the operation of diesel locomotives (with possibly outdated drive units) or inland waterway vessels (with possibly also outdated drive units). In this case, the introduction of a driving ban on these main roads in the congested areas will not significantly reduce emissions pollution unless the operation of the relevant diesel locomotives or inland waterway vessels is restricted. The approach presented here, on the other hand, makes it possible to determine emissions in a particular, spatially delimited area, namely the observation area, by individually detecting the means of transport actually passing through.

A favorable embodiment of the approach proposed here is one in which, in the step of reading, the identification parameter is read in using an optical or electromagnetic image of the means of transport and/or information read out wirelessly from a memory of the means of transport. For example, the identification parameter can be detected using an (optical) traffic observation camera or a radar image, as are often already available on roadsides for other purposes (for example, speed monitoring or traffic flow monitoring). It is also conceivable to use information read out wirelessly, such as that used to identify individual vehicles and calculate a toll when using certain traffic routes. Such an approach offers the advantage of increasing the possible uses of existing infrastructure.

A particularly favorable embodiment of the approach proposed here is one in which, in the step of reading, the identification parameter is determined by evaluating a detected license number of the means of transport and/or by evaluating a contour, a production model and/or a color of the means of transport. Such an embodiment offers the advantage that, by evaluating the license number, for example a license plate of a road vehicle, it is possible to access a very precise assignment of the currently detected means of transport to a quantity and/or type of emission. In particular, not only can the type or vehicle model of the means of transport be stored in a database of the licensing authority, from which type/model the emission is then determined as an emission value, but additional information can also be present, for example whether the detected means of transport has a catalytic converter, particulate filter or the like, and thus differs individually from other similar types of the means of transport. However, it is also conceivable that the contour or silhouette of the means of transport, a specific production model (of a vehicle manufacturer) and or a color of the means of transport (and, for example, knowledge of which manufacturer provides which vehicle with which color) is used to ascertain the type of the means of transport, wherein the memory then also contains a specific assignment of the emissions to this type of the means of transport.

An embodiment of the approach proposed here is particularly advantageous in which an identification parameter of a road vehicle, in particular a passenger car, a truck, a motorcycle, or a rail vehicle, an aircraft and/or a ship is read in as a means of transport during the step of reading. Due to the large number of possible means of road transport and the widely known emission effect of each type of these means of road transport, detecting or reading in the identification parameter of a road vehicle is in particular a good way to precisely estimate the emissions pollution on a road when it is ascertained which vehicles or which types of vehicles are currently driving on this road. However, other transport routes, such as railroads, waterways or air routes, can also be efficiently monitored for emissions pollution using the approach presented here, and a distinction can thus be made between traffic-related emissions pollution and, for example, industrial emissions pollution, which can be relevant for political decision-making processes, for example.

Particularly advantageous is the embodiment of the approach proposed here in which, in the step of ascertaining, a quantity and/or type of a gas emitted by the means of transport during the travel, in particular carbon dioxide and/or a nitrogen oxide, a sound level, a quantity and/or type of particulate matter, and/or a strength of an electromagnetic field is ascertained as the emission value. Compared to conventional approaches, such an embodiment offers the advantage of being able to assess an emission not only on the basis of measurements with specific measuring probes that only provide local data related to a specific emission value. It is thus possible to ascertain the currently most relevant emission values with regard to combustion residues, such as carbon dioxide or nitrogen oxide, or particulate matter for means of transport based in the observation area. In addition, however, if the emission of a type of the means of transport is known in a plurality of emission value categories and stored in the memory, it is also possible to determine a sound level and/or an electromagnetic field as an emission, which may also become relevant in the evaluation of traffic flows in the future, for example, even if the drive train of these means of transport no longer has an internal combustion engine.

A particularly efficient and precise embodiment of the approach proposed here is one in which the step of ascertaining is carried out using a database stored in a traffic monitoring authority. Alternatively or additionally, the steps of the method can be carried out in a device of a moving carrier unit. For example, such an approach can be carried out by an environmental agency with a mobile vehicle in order to ascertain emissions in areas where there are no stationary sensors such as traffic flow monitoring cameras. This makes it possible to ascertain traffic-related emissions very flexibly in terms of location and/or time.

A particularly advantageous embodiment of the approach proposed here is one in which, in the step of reading, a speed of the means of transport is read in and in which the emission value is ascertained using the speed of the means of transport in the step of ascertaining, in particular in which the speed and the identification parameter are determined using a measurement result of a shared or identical sensor. The speed parameter in particular plays a major role in ascertaining the specific emissions since means of transport usually emit very different types and/or quantities of emissions or pollutants at different speeds depending on their type. The assignment of these types and/or quantities of emissions of the individual types of the means of transport at different speeds is also known (for example through approval processes of the type or model of the means of transport) and stored in the memory, e.g., as a measured value curve, so that the evaluation of this information is technically very simple, or can be implemented by conversions with known type-specific characteristic curves, and thus makes a significant increase in the precision or prediction of the actual emissions pollution in the observation area possible.

According to a further embodiment of the approach proposed here, in the step of reading, an average speed of the means of transport during the travel through a predefined route portion can be read in as the speed of the means of transport. Such a predefined route portion can, for example, be a portion in which a road portion surveillance, i.e., the determination of an average speed in a monitoring area, is carried out in order to be able to identify speeding over a longer period of time with respect to a route portion. Such an embodiment of the approach proposed here offers the advantage of keeping the effect of a measurement error as low as possible when measuring the current speed, and, on the other hand, of also being able to take into account, for example, in the emission behavior, the effects of operating the engine over a longer portion of the route, since the release of emissions when the means of transport is driving fast usually causes turbulence in these emissions, and a highly precise resolution of the emissions pollution thus does not usually correspond to the actual local emissions pollution at all.

A particularly favorable embodiment of the approach proposed here is one in which, in the step of reading, an operating mode of the means of transport is read in and in which, in the step of ascertaining, the emission value is ascertained using the operating mode, in particular in which the operating mode is read in from an interface to a different detection unit than the detection unit detecting the identification parameter. An operating mode can, for example, be understood as one drive mode of a plurality of possible drive modes of the means of transport. For example, modern means of transport are already designed as hybrid means of transport which, in addition to an internal combustion engine, also have an electric drive motor that can be used for short routes. However, if the electric drive motor is used for the actual, current movement of the means of transport, the emission behavior of this (type of the) means of transport differs fundamentally from the emission behavior of this (type of the) means of transport with a different drive mode, so that significant errors occur in the ascertainment of the actual emissions pollution in the observation area when the wrong drive modes are taken into account. Such an embodiment therefore offers the advantage of a significantly better and more precise ascertainment of the emissions pollution over a particular investigation area. The operating mode can be ascertained with particular certainty if it is identified by measured values that are based on or supplied by a different sensor or detection unit than the basic data used to ascertain the identification parameter; for example, the operating mode can be ascertained using a microphone, whereas the identification parameter is determined from the optical image of the means of transport. By using the microphone, a noise level can be detected very reliably, which differs if the means of transport is operated with an internal combustion engine instead of an electric drive.

Due to the trend towards customization of means of transport, the operator of a means of transport often adds external units or modifications to the means of transport. For example, such modifications could be a rear carrier, a roof rack (for example, a ski box) or a spoiler, which individually change the drag behavior of the type of the means of transport compared to a general type of the means of transport stored in the memory. Such modifications to the means of transport thus also influence the emission behavior. In order to be able to determine the emission values in the observation area as precisely as possible, according to one embodiment, in the step of reading, modification information representing a unit attached externally to the means of transport can be read in, with the emission value being ascertained using the modification information in the step of ascertaining. For example, in the step of ascertaining, an increased air resistance due to this externally attached unit can be estimated, and an increased drive requirement or an increased drive force for the means of transport can be estimated therefrom, the same leading to additional emissions that can be used for an adapted ascertainment of the emission value using the type of the means of transport stored in the memory. The empirical ascertainment and assignment of relevant emission factors is particularly advantageous for the simple and efficient estimation of total emissions.

A particularly flexible and efficient embodiment of the approach proposed here is one in which, in the step of reading, at least one further identification parameter representing at least one type of a further means of transport is read in, wherein, in the step of ascertaining, at least one further emission value of a further means of transport is ascertained from the memory that stores an assignment of the at least one further identification parameter to the further emission value, and wherein, in the step of outputting, the ascertained further emission value is output to the interface in order to provide the further emission value. In this way, not only can the emissions from individual means of transport in the observation area be ascertained, but the emissions for a plurality of means of transport can be estimated and an emissions pollution in the observation area, for example for a longer period of time, can thus be ascertained. The approach presented here can therefore not only be used for two means of transport in the observation area but also be extended to estimate the emissions from any number of means of transport. The emissions also do not have to concern the same physical quantity, such as a type and/or quantity of a certain gas, but can also concern different parameters, such as the type and/or quantity of particulate matter, a sound level or the like.

A particularly advantageous embodiment of the approach proposed here is one in which, in the step of outputting, the ascertained emission value is output to a display unit, a toll calculation unit for calculating a traffic route usage charge for the means of transport, and/or a traffic control unit for controlling a traffic flow comprising the means of transport. Such an embodiment offers the advantage of indicating the emissions caused by a driver's driving behavior to the driver of the means of transport by displaying the emission value, for example at the edge of the roadway, and thus of working towards low-emission driving of this means of transport. However, it is also conceivable to use economic arguments to encourage low-emission operation of the means of transport by calculating an emissions-based traffic route usage charge, such as a road toll. Finally, a traffic flow can also be influenced, for example slowed down, by a corresponding traffic control unit, for example in order to keep emissions pollution in a traffic corridor as low as possible. For example, weather information, such as the current presence of wind or strong sunlight, can also be taken into account in order to optimize the emissions pollution in this traffic section. For example, means of transport such as vehicles can produce higher emissions if they can be quickly dissipated by wind or quickly reduced by strong solar radiation. Headwinds, on the other hand, can also lead to increased fuel consumption and thus to higher emissions.

Embodiments of these methods can be implemented in software or hardware, for example, or in a hybrid form of software and hardware, for example in a control unit.

The approach presented here also creates a device that is designed to carry out, control, or implement the steps of a variant of a method presented here in corresponding setups. The object on which the invention is based can also be achieved quickly and efficiently by means of this embodiment variant of the invention in the form of a device.

For this purpose, the device can have at least one computing unit for processing signals or data, at least one storage unit for storing signals or data, at least one interface to a sensor or an actuator for reading sensor signals from the sensor or for outputting control signals to the actuator, and/or at least one communication interface for reading or outputting data that are embedded in a communication protocol. The computing unit can, for example, be a signal processor, a microcontroller, or the like, wherein the memory unit can be a flash memory, an EEPROM, or a magnetic memory unit. The communication interface can be designed to read or output data wirelessly and/or in a line-bound manner, a communication interface that can read or output line-bound data being able, for example, to read these data electrically or optically from a corresponding data transmission line or output them into a corresponding data transmission line.

In the present case, a device can be understood to mean an electrical device that processes sensor signals or data signals, and outputs control signals and/or data signals depending thereon. The device may have an interface, which may be designed as hardware and/or software. In a hardware design, the interfaces can, for example, be part of what is known as a system ASIC, which includes a wide variety of functions of the device. However, it is also possible for the interfaces to be separate integrated circuits or at least partially consist of discrete components. In a software design, the interfaces may be software modules which, for example, are present on a microcontroller in addition to other software modules.

Exemplary embodiments of the approach presented here are shown in the figures and explained in more detail in the following description. In the figures:

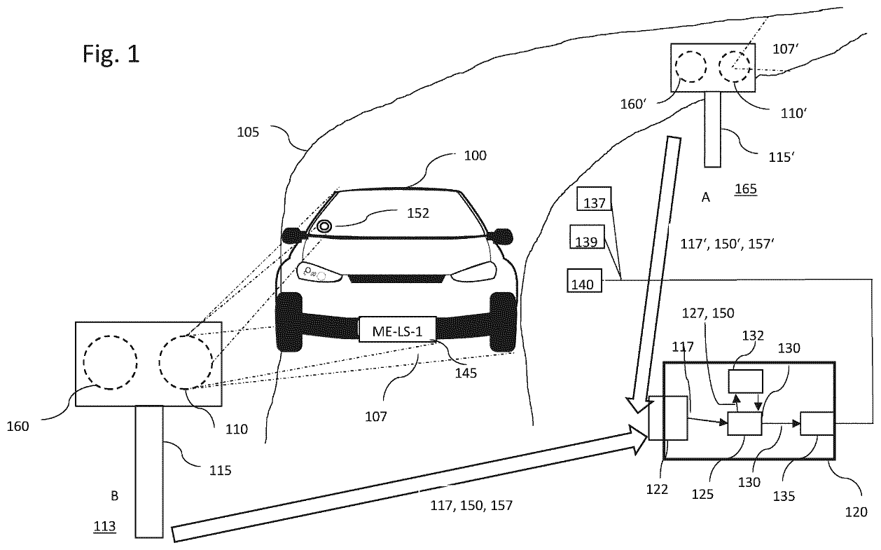

FIG. 1 is a block diagram of a device according to an exemplary embodiment; and

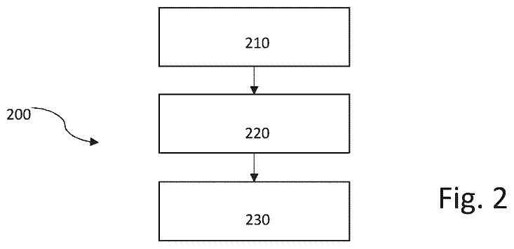

FIG. 2 is a flow diagram of a method according to an exemplary embodiment.

In the following description of advantageous embodiments of the present invention, the same or similar reference numerals are used for the elements that are shown in the various figures and act similarly, such that a repeated description of these elements is dispensed with.

FIG. 1 is a schematic representation of a scenario in which a means of transport 100 travels on a road or roadway 105. In this case, the means of transport 100 is designed as a road vehicle, specifically as a passenger car, and is detected by a sensor 110 in an observation area 107 of the roadway 105. For example, the sensor 110 is mounted on a pillar 115 next to the roadway 105 at a position 113. For example, the sensor 110 is designed as a camera that captures an optical image of the means of transport 100 in the observation area 107. However, it is also conceivable that the sensor 110 is designed as a radar sensor, which can also detect the means of transport 100 in the observation area 107. From the image (for example, the optical image of a camera as a sensor 110 or the electromagnetic image of the sensor 110 as a radar sensor) of the means of transport 100, an identification parameter 117 is then ascertained, which is transmitted to a device 120, for example. In the device 120, the identification parameter 117 is read in an input interface 122 and transmitted to an ascertainment unit 125. A type 127 of the means of transport 100 moving in the observation area 107 can be recognized either in the input interface 122, the ascertainment unit 125 or even already in the sensor 110. For example, such a type 127 of the means of transport moving in the observation area 107 may represent a particular vehicle model from a particular vehicle manufacturer. For this type 127 of the means of transport 100, emission values 130 for one or more emission variables are then usually already available from a previous approval procedure and are stored in a corresponding memory 132. Such emission variables may represent, for example, a type and/or quantity of one or more gases (such as carbon dioxide or a nitrogen oxide), of particulate matter, a sound level and/or an electromagnetic field emitted by the means of transport 100. The emission value(s) read out from the memory 132 in the ascertainment unit 125 can then be output from the device 120 via an output unit 135 to one or more further unit(s), such as a display unit 137, a toll calculation unit 139 and/or a traffic control unit 140.

The scenario shown schematically in FIG. 1 then makes it technically very easy to ascertain very precisely the specific emissions pollution occurring in the observation area 107, by linking to mostly already known emission data. In particular, because very precise emission data or emission values 130 are known for currently operated vehicles in approval procedures for each vehicle type or type 127 of the means of transport, for example with regard to exhaust gas and/or particulate matter emissions, these data can be used very precisely for the estimation of such an emissions pollution. In this way, it is possible to dispense with the very cost-intensive provision of units for environmental analysis at the edge of the roadway, for example at the position 113, for monitoring the emissions pollution in the observation area 107, which is also only designed with regard to the precise detection of a specific emission parameter 130, such as particulate matter or carbon dioxide.

The approach proposed here works very precisely if, for example, a license number 145 of the means of transport 100 is automatically detected by the sensor 110, evaluated (for example by means of automatic license plate recognition ANPR) and transmitted to the device 120 as part of the identification parameter 117. It is also conceivable that only an optical image of the means of transport 100 is detected in the sensor 110 and is transmitted to the device 120 as the identification parameter 117, wherein the type 127 of the means of transport 100 is then recognized in the device 120, for example in the input interface 122 and/or the ascertainment unit 125 or manually evaluated in a back office. If, for example, recourse is then made in the device 120 to the memory 132, which holds a current vehicle database of a licensing authority, such as the Federal Motor Transport Authority (KBA) in Germany, both the type of the means of transport 100 recognized in the observation area 107 and optionally, for example, additional modifications and/or installations on or in the means of transport 100, which have an influence on the emission behavior of the means of transport 100, can be taken into account very precisely. For example, the memory may also contain an indication that the means of transport has a particularly efficient catalytic converter or particulate filter and thus reduces emissions, for example with regard to certain exhaust gases and/or particulate matter emissions, compared to other vehicles of the same type 127 of a means of transport.

The type 127 of the means of transport 100 may also be identified by evaluating the information provided by the sensor 110, for example with regard to a contour of a silhouette, a recognized vehicle model, a recognized vehicle make and/or a recognized color of the means of transport 100, for example also by drawing on data stored in the memory 132.

The approach presented here works particularly efficiently if not only the type of the means of transport 100 is recognized, but also how fast the means of transport 100 is traveling in the observation area 107, for example. This results from the fact that the same means of transport 100 can, for example, have a higher emission value 130 at high speed than at low speed. If the speed is then also detected and transmitted as a corresponding speed parameter 150 from the sensor 110 to the device 120, a specific, currently valid emission value 130 for the means of transport 100 recognized in the observation area 107 can be determined, for example likewise with recourse to data stored in the memory 132, and can be output via the output unit 134. For example, in the sensor 110, such a speed can be identified in that, in the case of a camera as a sensor 110, two images are detected one inside the other at different times, and it is ascertained how far the means of transport 100 has moved in the observation area 107 in the time interval that has elapsed between the two images. This makes it very easy to ascertain the current speed of the means of transport 100 using known means. However, it is also conceivable that the sensor 110 has a radar sensor part for ascertaining the speed, which determines the speed of the means of transport 100, for example by utilizing the Doppler effect.

In order to make possible a particularly precise determination of the type of the means of transport 100 and/or the speed of the means of transport 100 in the observation area 107, the sensor 110 can also additionally have an illumination unit for increasing the brightness in the observation area 107 (for example by means of a flash). In addition, for example, one or more corresponding environmental badges 152 can also be recognized in a means of transport 100, which badges on the one hand provide an indication of the emission behavior of the means of transport 100 and on the other hand can be used to verify or check the plausibility of the type of the means of transport 100.

In recent times, some means of transport 100 with more than one possible drive motor have already been approved or are on the road. Hybrid vehicles as a means of transport 100 are of particular relevance here since the emissions pollutions of these vehicles as means of transport 100 differ significantly depending on which drive mode or operating mode is currently activated. If, for example, the drive by means of an internal combustion engine is selected as the operating mode of the means of transport 100, significantly higher emission values are emitted into the environment with regard to certain exhaust gases or particulate matter as combustion products than is the case for the operating mode when the means of transport 100 is driven by an electric motor. On the other hand, higher electromagnetic fields are emitted when the electric motor is operated as the drive motor of the means of transport 100 than is the case when the internal combustion engine is selected as the drive of the means of transport 100. In order to then determine the correct current emission values 130 of the means of transport 100 in observation area 107, an operating mode parameter 157, which represents the current operating mode or the current drive mode of the means of transport 100, should therefore also be transmitted to the device 120. For example, the operating mode can be recognized by using a microphone 160 arranged next to the sensor 110, by evaluating how high the sound level of the means of transport 100 is when it passes the microphone 160. If, for example, the operating mode of the means of transport 100 in which the electric motor is activated is selected, this leads to a significantly lower sound level that can be picked up by the microphone 160 than is the case for the operating mode of the means of transport 100 in which the operation of an internal combustion engine as the drive unit has been selected.

In order to avoid an incorrect determination of the emission value(s) 130 output by the vehicle, for example due to an incorrect speed determination, it may be provided that an average speed instead of the current speed is to be used in the device 120. For this purpose, for example, a further sensor 110′ can be arranged on a further column 115′ at a pre-position 165 in the manner of a road portion surveillance, which further sensor then recognizes a means of transport 100 located in a further observation area 107′ and transmits this image, provided with a corresponding time stamp, as a further identification parameter 117′ via the input interface 122 of the device 120. The identification parameter 117 provided by the sensor 110 should then be provided with a second time stamp, wherein the spatial distance of the sensor 110′ and the sensor 110 should then be known, and a time period in which the means of transport 100 moves from the pre-position 165 to the position 113 can also be ascertained from the difference between the times of the time stamp and that of the second time stamp. This allows the average speed of the means of transport 100 between the pre-position 165 and the position 113 to be ascertained. It is also conceivable that a further microphone 160′ is used in addition to the further sensor 110′ in order to also determine in which operating mode the means of transport 100 is being operated in the further observation area 107′. By using such an average speed, it is thus possible, for example, to compensate for a measurement error of the speed at the position 113 on the one hand and, on the other hand, a briefly increased emission value at the position 113, for example due to a fast driving style of the means of transport 100 at the position 113, is not too significant when considering the overall emissions pollution.

In principle, the setup shown in FIG. 1 can also be used to examine or take into account a plurality of means of transport, such as the means of transport 100, in the observation area 107 with regard to the associated emission values 130, and thus to estimate an overall emissions pollution in the observation area 107 caused by the means of transport traveling on the roadway 105, for example.

In summary, it should be noted that FIG. 1 shows a vehicle as a means of transport 100 traveling on a route portion AB (from point A to point B). Between points A and B, there is a road portion surveillance 100 by means of two traffic monitoring devices or sensors 100 and 100′, which are mounted on a mast or tripod 115 or 115′. Such a traffic monitoring device may, for example, be characterized by at least one sensor unit 110 or 110′. In this example, the sensor unit 110 is a camera/video sensor with automatic license plate recognition (ANPR). The ANPR camera can also be installed in a further sensor unit, or a stereo video in the form of two or more video sensors can also be present; contrary to the description of FIG. 1, in addition to the sensor 110, a further sensor 160 could thus also be provided, both designed as a camera. However, a unit 160 can also be designed as a microphone, as described in more detail above, or as a flash or an illumination unit. The vehicle as a means of transport 100 can be identified, for example, by its make, model and/or color. In addition, the environmental badge 152 and a vehicle license plate 145 can also be recognized.

At point A, the vehicle is detected as a means of transport 100 for the first time, with a unique time stamp. For example, the vehicle as a means of transport 100 is detected in its entirety, including make, model and color. In addition, the license number and/or the environmental badge is, for example, detected, or their absence is detected. Vehicle occupants can also be detected and counted in the vehicle as a means of transport 100. At point B, the named characteristics are detected again, as at point A, and a second time stamping takes place. The collected data from the measurement points A and B are sent to a back office, such as the device 120. In the back office or the device 120, the data are analyzed and evaluated using further data.

The approach presented here is particularly advantageous in that it can be implemented with existing systems. In particular, a contribution to reducing the man-made climate catastrophe caused by excessive CO₂ emissions (from vehicles as means of transport) can be mentioned here. However, other vehicle emissions such as NOₓ and diesel particulates could also be detected or estimated using the approach presented here.

For implementing the approach presented here, systems can be used that are already very good at reading license numbers, recognizing vehicles (make, model, color, contour, etc.) and/or measuring P2P (point-to-point) speeds. These parameters can also be transmitted to a device arranged remote from the detection or measurement location, as a back office, and evaluated there.

The approach presented here is then used to combine customer/market benefits and climate protection requirements with the capabilities of already known or installed systems. A user of the approach mentioned here will usually be a municipality or authority that is precisely the target group of the results obtained here, i.e., the one that is interested in emission monitoring in addition to speed monitoring. Complex chemical measurements are currently being carried out directly at the edge of the roadway or in special measuring vehicles. The disadvantage here, as already mentioned, is the measurement across a plurality of lanes and the influence of weather and wind. If, for example, only one emissions pollution in one direction of travel is to be measured, turbulence from the vehicles and winds will lead to measurement distortions since the emissions from the vehicles in both directions of travel are likely to be superposed. At the same time, an additional measurement of the emissions in industrial areas must be ascertained so that incorrect evaluations in the assignment to traffic are reduced. In addition, the approach presented here could be used to offer further environmental analyses based on measurements with the system presented here and on derived estimates.

As already mentioned, the approach presented here is particularly favorable because the system used here is already used in a basic form for normal point-to-point (P2P) speed measurements. The license plates are read or evaluated using ANPR in the back office or the device 120. In addition, a comparison would then be carried out with a vehicle database (comparable with data from the Federal Motor Transport Authority), which determines the drive mode (combustion engine, electric car, hybrid) and takes into account the associated data or emission values 130, e.g., of CO₂ emissions. Since the CO₂ emissions of means of transport 100 with combustion engine often correlate with the speed, the measured speed value should then advantageously be included as a factor in the emissions estimate for a very accurate prediction of the emissions of such a vehicle as a means of transport 100. It would also be conceivable, for example, to determine per capita emissions by converting the emission values per vehicle occupant (for example, in an in-cabin measurement); this could later be converted back into emission values per vehicle. An attempt can also be made to introduce a distinguishing criterion or to take into account in determining the emission value(s), how the operating mode of a hybrid vehicle can be recognized, for example via additional directional microphones.

In the event of an alarm regarding excessive emission values, one or more displays 137 can, for example, be activated (for example, real-time representations of outlined CO₂ footprints on the globe), or else targeted communications regarding obsolete vehicles and SUVs with high CO₂ emissions could also be initiated by the authorities. CO₂ (or general emission values) traffic lights could also be introduced.

Furthermore, speed-dependent emission value ascertainments (approximations, statistical estimates) could be more accurate or at least provide a good supplement to chemical measurements. These measurements/estimates could be of particular importance in front of tunnels and wooded areas and may lead to route detours or closures.

With the approach presented here, a method for environmental analysis and estimation of vehicle emissions, for example using an ANPR camera, can thus be realized. For this purpose, for example, an image of a license plate of the vehicle as a means of transport 100 and/or of an environmental badge 152 and/or of a vehicle can be taken. Optionally, alternatively or additionally, a transponder (for example in an on-board unit OBU) or an RFID tag can be read out in order to identify a type of the means of transport 100. The vehicle speed/acceleration can also be ascertained. Furthermore, for example, associated vehicle data, such as drive mode, consumption, CO₂ emissions, NOₓ emissions, noise levels/sound levels, are ascertained from at least one database or memory to determine at least one first emission value 130. Similarly, at least one second emission value can also be determined, for example also taking into account the measured speed value for the means of transport 100. Optionally, an alarm/signal can be output to a display panel 137.

It is also conceivable that an occupant detection system detects a number of occupants and calculates at least one of the ascertained emission values per occupant.

The speed ascertainment can also be an ascertainment of an average speed, which was ascertained in a road portion surveillance system, for example, and the emission value ascertainments then relate to the same route portion.

In order to reduce the load on the system in accordance with the approach presented here, an emission value can also be ascertained for every nth vehicle and a statistical ascertainment can be carried out for the entirety of the vehicles or means of transport 100 in the measured portion or observation area 107.

It is also possible that a toll is calculated on the basis of the ascertained emission values 130 or that a route is closed (for example, in front of tunnel entrances, nature conservation areas, health resorts) or that individual vehicles are diverted or separated.

In a particularly favorable variant, a distinction between different operating modes, for example in hybrid vehicles, can be made by at least one directional microphone (for example when distinguishing combustion engine noise yes/no), and this knowledge can be included in the ascertainment of the emission values (wherein no combustion engine noise, for example, indicates zero emissions with regard to certain emission values, i.e., purely electric driving).

It is also possible to distinguish between operating modes in hybrid vehicles using at least one thermal imaging camera.

A procedure in which exactly one shared license number reading is carried out for the determination of the vehicle owner, the speed ascertainment and the emission value ascertainment is favorable.

The approach presented here is particularly efficient because both the speed ascertainment and the emission value ascertainment can be carried out based on the measurement of one and the same sensor or one and the same sensor per camera.

A vehicle ascertainment can also be ascertained on the basis of vehicle identification data, such as make, model and color, in accordance with a procedure presented here.

An interface to a chemical monitoring system (CO₂ sniffer) can also be integrated into a system as presented here to check the plausibility of the measured values from further sensors.

In order to further refine the estimation of emissions, emission-influencing variables such as modifications or installations external to the means of transport can also be detected (for example, use of roof boxes, roof racks, ski boxes, excess weight through recognizable low position of the vehicle). The variables can then be evaluated with different factors to ascertain the total emissions of vehicles or means of transport.

In one exemplary embodiment, the emission values may relate to emissions of particulate matter produced as an abrasion product (tires, brakes, clutch, lubricants (oils, greases)). The emission values can also relate to emissions as a sound pressure/noise level. The results of the ascertained data can also be made available for a navigation interface. Alternatively or additionally, the ascertainment of NOₓ emissions can also be combined with a location-based query of UV radiation levels, for example via a weather service via Web API (for example, AccuWeather via IoT), and the route-related ozone pollution (smog) can be ascertained or predicted therefrom.

The approach presented here can also take into account a temperature measurement and/or a measurement of a gradient or a slope, wherein these data are read in as IoT data, for example, and are taken into account in a supporting manner, or utilized, to ascertain the emission value for the means of transport in the observation area.

The emission values provided by means of the approach presented here or the sensor data from the camera or the radar/lidar sensor (for example, vehicle frequency, type, speed, driving behavior, temperature, incline, etc.) can also be linked to a chemical measuring station for teaching AI (artificial intelligence) networks. When detecting hybrid vehicles, these AI networks could also use statistical surveys by third parties, such as automobile clubs, to estimate which drive mode is most likely to be selected at which speed and under which other conditions on a specific route portion, and corresponding specific emission values can then be automatically assigned, which can then be included in the overall balance of emissions.

In principle, the approach presented here also includes a monitoring system for carrying out a variant of a method presented here. A computer program product for executing a variant of a procedure presented here is also presented.

The approach presented here has a particularly advantageous effect on cost-effective ascertainment and prediction of different vehicle emissions based on images/video recordings of vehicles and evaluation of vehicle-specific data, preferably (but not necessarily) using ANPR. A corresponding sensor system to be used is often already available in speed monitoring systems and can also be used for the approach presented here. It is thus possible to precisely assign emissions to the individual means of transport or vehicles or to vehicle types in defined route portions. It is also possible to predict emission values in the future and/or to further process ascertained data for navigation devices.

It is particularly advantageous that one embodiment of the approach presented here can preferably be designed in one and the same housing, although a plurality of individual sensors in different housings is also conceivable for implementing the approach presented here. At best, all measurements are carried out with exactly one sensor per camera; a one-pole solution (i.e., a sensor system on the same support column) is also conceivable.

Spot measurements or P2P (route portion measurements) with at least two measurement points/portion points are also possible. In the future, such measurements are also suitable, by implementing the approach presented here in at least one drone (UAV) or in a drone network or on mobile vehicles (motorcycles, vans, bicycles, etc.) as a mobile measuring station, as an alternative between stationary or mobile emissions pollution measurement by means of transport. The data collected to identify the means of transport or type of means of transport could also be transmitted or read from an OBU (on-board unit) or an RFID transponder. Such data can also be transmitted by the vehicles, and these data can be linked to a route portion (for example, by means of two position sensors), and an environmental analysis can be carried out on the basis of these data. It would also be conceivable to transmit the procedure presented here to the area of ships and/or airplanes and other vehicles or road users.

The environmental balance is not limited to the detection of gases such as CO₂, NOₓ, or soot particles, etc., but also includes all environmentally relevant substances and physical, electrical, chemical, etc. emissions that are recorded in databases. Any emissions could be calculated using this method in the future; for example, if the amount of heat emissions from ships were to have an environmental impact, the method could also be applied to these emissions.

Further details need to be taken into account with respect to the influence of the vehicle speed on emissions. Various studies have been carried out by respected organizations and associations. The ADAC automobile club recently confirmed, for example, that speed has little influence on CO₂ emissions at speeds between 30 and 50 km/h in urban areas. However, NOₓ emissions are particularly high at low speeds. The German Federal Environment Agency has had figures ascertained which show significant differences in CO₂ emissions, at least on freeways, depending on different speed limits.

It is also interesting to estimate particulate matter emissions, taking into account particles such as abrasion from tires, brake pads, brake disks, clutches, clutch disks, piston rings, oil, hydraulic fluid, other lubricants, etc., since it has been proven that particulate matter is not only generated from combustion processes but often from abrasion products. The abrasion data of the materials used in the individual types of the means of transport could be available in databases or initially be ascertained by means of in-situ measurements, for example by identifying the type of tire (including, for example, a query of the abrasion behavior of this type of tire from the memory).

Electric vehicles can also generate “electrosmog” or lithium smog or high-frequency sound waves, for example from the electric drive. In the case of vehicle occupants, but also pedestrians, for example, the use or only the theoretical presence of a cell phone would have to be taken into account. E-bikes, i.e., bicycles with an electric drive, could also be detected and accounted for. Here, a camera could be used to distinguish between “pedaling with muscle power” and purely electric operation, to improve the quality of the analysis. These are also emissions that could be ascertained.

A reaction product, by-product or reactant analysis is possible in a similar way for any type of existing or newly generated road users/means of transport, in particular for fuel cell vehicles.

Increasingly, people are no longer just talking about “air pollution,” but also about “light pollution.” Lighting sources on means of transport can emit light. This type of emission can also be analyzed using the corresponding data (type of lighting, light source, light source output, luminous flux, light color, etc.).

Noise is an increasing burden in large cities, and also in the countryside or in areas of retirement homes, health resorts, etc. Noise emissions can also be measured (for example, using directional microphones) or ascertained from the vehicle data in the same way as the above-mentioned emissions and also combined with speed measurement or acceleration measurement, for example, to ascertain dynamic noise emissions. Electric vehicles also emit noise, e.g., rolling noises.

With regard to vehicle ascertainment, a mixed form of the recognition method is also possible: At entry point A, an “internal” database is first used, i.e., a vehicle is recognized using image recognition methods (make, model color), such as a Tesla model. In this case, there is no further query via the owner database, e.g., the KBA, since it is an electric vehicle (Tesla only builds electric vehicles). If it turns out shortly before measurement point B that these data are insufficient, a license number query is then made at point B, or the associated emission data are queried there. For statistical purposes, a later evaluation in a back office or the device 120 is sufficient. At point B, not all the data need to have been evaluated yet. It is also conceivable to superimpose different camera angles for a better assessment of make, model, and color. For example, different installation angles of the cameras are used for this purpose. Networking with neighboring road portion surveillance systems would be helpful here, in particular if these systems also allowed a further angular displacement, so that at least a side view can be ascertained or “simulated.”

With regard to repeated passing, it will often happen that the same vehicles pass by the same road portion surveillance systems several times a day or every day. For these cases, an internal data collection can be stored, which allows the environmental data (internal data) to be assigned to the license number quickly and reliably without the need for new queries. All conceivable energy supply options of the systems presented here, such as solar, fuel cell, battery, etc., are feasible.

In general, an approach is thus presented here that proposes a method for environmental analysis and estimation of vehicle emissions, for example using an ANPR camera. First, a vehicle can be detected, after which, for example, corresponding environmental characteristic data (emission values, including sound levels) can be read in. It is also possible to ascertain a route portion and/or the vehicle's emissions in relation to the route portion. The steps carried out can be repeated for further vehicles. The sum of the emissions for the route portion can then be ascertained, followed, for example, by an optional output of an alarm/signal/single value/total value to a display panel/output interface. Finally, it is also possible to analyze the ascertained data to predict emissions at later time intervals.

The approach presented here can particularly advantageous in connection with an ANPR, the evaluation of data from an OBU or also the evaluation of a detected badge, and/or taking into account, for example, a speed dependency or acceleration dependency of the emission values, a dependency of the emission values on a number of persons, etc.

The emissions can also be based on in-situ measurements of modern, for example self-driving, cars. The evaluation of “zero emissions” from such vehicles, for example e-vehicles, alone can be efficiently included in the environmental analysis.

A connection or report can also be made to navigation devices or CAVs (connected autonomous vehicles). If the emission values are transmitted to a navigation unit, for example in the form of a traffic control unit 140, detour recommendations could be issued.

It is also conceivable that the approach or system presented here could be linked to variable message signs for controlling environmentally friendly vehicle flows to prevent stop-and-go phases. Acceleration profiles can also be measured and taken into account in such a way that the measurement can be carried out either directly via the video sensor or via radar/lidar sensors, for example. A prediction can also be made from learned data, for example by means of AI (artificial intelligence, deep learning) or statistical surveys from defined time periods, for example to the effect that a traffic jam always occurs at the same intersection at 8 a.m. on Mondays. Finally, the approach presented here can also be used to detect whether luggage, roof racks or ski boxes are being driven with sagging weight, which also has an effect on the emission values of the means of transport.

An embodiment in which the vehicles emitting the exhaust gases are detected per route portion and time is also conceivable. This can also be used to derive an estimated concentration of exhaust gases, or specifically NOₓ. The current weather data can also be queried, for example via Web API (for example, AccuWeather), in order to query the local temperature and UV index and take them into account when ascertaining the emission values. If both values, i.e., number of emitting vehicles and weather data, are above a limit value, a warning is, for example, generated that warns of favorable conditions for smog. The warning is transmitted to the back office or the device 120 via the system interface, for example, and can be combined with a traffic guidance system to divert traffic away from the hotspot.

It should be noted here that “summer smog” (also known as photosmog, ozone smog or L.A. smog) can be defined as the pollution of the air near the ground (smog) caused by a high concentration of ozone. It occurs in sunny weather and is formed from nitrogen oxides and hydrocarbons in combination with the sun's UV radiation. Ground-level ozone attacks the respiratory system and damages plants and animals. Ozone pollution in the environment is ascertained by air measuring stations and regularly depicted and published in pollution maps. With regard to the formation of this type of smog, it should be noted that ground-level ozone is formed with the help of nitrogen oxides and is influenced by solar radiation. Nitrogen dioxide is split into nitrogen monoxide and an oxygen atom by UV radiation. According to the online encyclopedia Wikipedia, this atomic oxygen combines with an oxygen molecule to form ozone as follows:

NO₂+light (λ<420 nm)→NO⋅+⋅O⋅

⋅O⋅+O₂→O₃

The temperature (from the physical sensor/database) at the measurement location can also be taken into account as a parameter for calculating emissions. It is also conceivable to take into account the gradient at the measurement point as a parameter for calculating emissions. In principle, a neural network can also be trained using data from real emission measuring stations (chemical) to take into account individual measured variables (for example, vehicle frequency, type, speed, driving behavior, temperature, gradient, etc.) in the overall result.

Thus, a possibility for combining ANPR speed measurement and ANPR environmental analysis is presented here. Estimates and predictions of emissions (CO₂, NOₓ, smog/ozone, particulate matter, noise, etc.) can be made. All input data for ascertaining these emissions are usually contained in the vehicle registration document or a corresponding memory and can be calculated using ANPR in combination with data evaluations in the back office or a corresponding device 120. A determination of empirical correction factors and influencing factors for the emission values, such as speed, acceleration, weather data, temperature, UV index, gradient/slope, roof luggage, etc.; many of these data are already available on a location-specific basis (keyword: IoT). The advantages of the approach presented here are as follows: Digital environmental analysis as an “add-on” to the route portion surveillance is very easy to implement and can be easily implemented in an existing technology (for example, measuring system at the measurement location and an evaluation unit in the back office are already available). No additional sensors are then required. Conventional chemical measurement methods, on the other hand, can only measure imprecisely per direction of travel and also measure industrial emissions. The “emission estimator” specifically ascertains/estimates the emissions per roadway/direction of travel. A wide variety of emission types can be detected with just one sensor. The inventive method is intended as a supplement to chemical measurements.

FIG. 2 shows a flow diagram of an exemplary embodiment of a method 200 for providing at least one emission value of a moving means of transport. The method 200 comprises a step 210 of reading in an identification parameter representing at least one type of the means of transport moving in an observation area. Furthermore, the method 200 comprises a step 220 of ascertaining the at least one emission value for the means of transport from a memory that stores an assignment of at least the one type of the means of transport to the emission value, wherein the emission value represents a parameter of an emission coming from the means of transport into an environment of the means of transport. Lastly, the method 200 comprises a step 230 of outputting the ascertained emission value to an interface in order to provide the emission value for calculating and predicting total emissions based on route, area or volume.

Thus, for example, the method presented here can be used to start ascertaining emissions by further processing the data, described in FIG. 1, of the traffic measurements at points A and B. In a second step, these data are then, for example, enriched with external data, for example from the Federal Motor Transport Authority, using ANPR data (license plate evaluation). These data can contain one or more parameters or all data from the vehicle registration document, e.g., emission data on CO₂ emissions. In a further step, the emissions behavior of an individual vehicle is calculated, for example in relation to the corresponding ascertained average speed and/or number of vehicle occupants. In a further step, a calculation is carried out for all the vehicles on route portion AB, or forecasts/predictions for future travels are calculated for this or another route portion.

If an exemplary embodiment comprises an “and/or” conjunction between a first feature and a second feature, this is to be read in such a way that the exemplary embodiment has both the first feature and the second feature according to one embodiment and either only the first feature or only the second feature according to a further embodiment.

1. A Method for providing at least one emission value of a means of transport, wherein the method comprises the following steps:
reading in an identification parameter that represents at least one type of the means of transport present in an observation area;
ascertaining the at least one emission value of the means of transport from a memory that stores an assignment of at least the one type of the means of transport to the emission value, wherein the emission value represents a parameter of an emission coming from the means of transport into an environment of the means of transport; and
outputting the ascertained emission value to an output interface in order to provide the emission value.

2. The Method according to claim 1, wherein, in the step of reading, the identification parameter is read in using an optical or electromagnetic image of the means of transport and/or information read out wirelessly from a memory of the means of transport.

3. The Method according to claim 2, wherein, in the step of reading, the identification parameter is determined by evaluating a detected license number of the means of transport and/or by evaluating a contour, a production model and/or a color of the means of transport.

4. The Method according to claim 1, wherein, in the step of reading, an identification parameter of a road vehicle, in particular a passenger car, a truck, a motorcycle, or a rail vehicle, an aircraft and/or a ship is read in as a means of transport.

5. The Method according to claim 1, wherein, in the step of ascertaining, a quantity and/or type of a gas, in particular carbon dioxide and/or a nitrogen oxide, a sound level, a quantity and/or type of particulate matter, and/or a strength of an electromagnetic field emitted by the means of transport during the travel is ascertained as the emission value.

6. The Method according to claim 1, wherein the step of ascertaining is carried out using a database stored in a traffic monitoring authority, as the memory, and/or wherein the steps of the method are carried out in a device of a moving carrier unit.

7. The Method according to claim 1, wherein, in the step of reading, a speed of the means of transport is read in, and wherein, in the step of ascertaining, the emission value is ascertained using the speed of the means of transport, in particular wherein the speed and the identification parameter are determined using a measurement result of a shared or identical sensor.

8. The Method according to claim 7, wherein, in the step of reading, an average speed of the means of transport during the travel through a predefined route portion is read in as the speed of the means of transport.

9. The Method according to claim 1, wherein, in the step of reading, an operating mode of the means of transport is read in, and wherein, in the step of ascertaining, the emission value is ascertained using the operating mode, in particular wherein the operating mode is read in from an interface to another detection unit than the detection unit detecting the identification parameter.

10. The Method according to claim 1, wherein, in the step of reading, modification and/or installation information is read in, which represents a unit externally attached to and/or installed in the means of transport, wherein, in the step of ascertaining, the emission value is ascertained using the modification and/or installation information.

11. The Method according to claim 1, wherein, in the step of reading, at least one further identification parameter is read in, which represents the at least one type of a further means of transport, wherein, in the step of ascertaining, at least one further emission value of a further means of transport is ascertained from the memory that stores an assignment of the at least one further identification parameter to the further emission value, and wherein, in the step of outputting, the ascertained further emission value is output to the output interface in order to provide the further emission value.

12. The Method according to claim 1, wherein, in the step of outputting, the ascertained emission value is output to a display unit, a toll calculation unit for calculating a traffic route usage charge for the means of transport, and/or a traffic control unit for controlling a traffic flow comprising the means of transport.

13. A Device configured to execute and/or control the steps of the method according to claim 1 in corresponding units.

14. A Computer program configured to execute and/or control the steps of the method according to claim 1.

15. A Machine-readable storage medium on which the computer program according to claim 14 is stored.
